(19) United States
(12) Patent Application Publication
(10) Pub. No.: US 2008/0294810 A1
(43) Pub. Date: Nov. 27, 2008

(54) Response control method and device

(75) Inventors: Makoto Satoh, Kanagawa (JP); Hiroshi Kariya, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/081,747

(22) Filed: Apr. 21, 2008

(30) Foreign Application Priority Data
May 23, 2007 (JP) 2007-137059

(51) Int. Cl. G06F 13/18

(52) U.S. Cl. 710/45

(57) ABSTRACT

When a device in a WUSB system is ready for transmission data upon reception of a data transmission request (WdtCTA) from a host device, the device outputs the transmission data at a time specified by the WdtCTA. Meanwhile, when the transmission data is not ready, the device estimates a preparation completion time for the transmission data, and when the estimated preparation completion time is before an earliest time at which the host device can retransmit the WdtCTA, the device sends an error response instead of a NAK response, to thereby request the host device to retransmit the WdtCTA. As a result, a data transmission efficiency between the host device and the device is improved.

### BACKGROUND OF THE INVENTION

1. Field of the Invention

The present invention relates to a response technology in a case where a device is not ready for transmission data upon reception of a data transmission request, in a system in which a device transmits data in response to a data transmission request from a host device.

2. Description of the Related Art

In a network using a wireless universal serial bus (WUSB) which is expected to attract wide attention as an interface for a personal computer (hereinafter, referred to as “PC”) because of its high-speed data transmission, there is employed a structure in which a host device controls a timing of data transmission and a device responds to a data transmission request from the host device, whereby data transmission is performed (see Wireless Universal Serial Bus Specification, Revision 1.0, May 12, 2005; Internet <http://www.usb.org/developers/wusb/docs/WirelessUSBSpecifica tion_r10.pdf>).

A connection mode of a WUSB network is a hub and spoke model, where devices are connected to a host device (for example, PC) that is located at the center. Communications between the host device and each device are point-to-point (PnP) in which connections are made one-to-one. The devices are, for example, a printer, a hard disk, a mouse, a digital camera, a game console, and a PDA.

In a WUSB cluster (hereinafter, also referred to simply as “cluster”) including a host device and devices that are connected to each other according to the WUSB standard, the host device manages the cluster (including devices in the cluster) using a Micro-scheduled Management Command (MMC). A description thereof is given below with reference to FIG. 5.

As shown in FIG. 5, the MMC is transmitted from the host device at a predetermined timing on a side of the host device. The MMC includes identification information of the host device and a transmission time of a subsequent MMC.

In a WUSB system, as for connections, there is employed device-oriented connection association where a device starts action. The host device notifies each device in the cluster by transmitting thereto host identification information or the like via the MMC. Note that the MMC also includes start time information (WdntsCTA; W: Wireless USB, CTA: Channel Time Allocation) for a Device Notification Time Slot (DNTS) which is specified by the host device so that each device is able to issue a connection request to the host device. The DNTS is a slot prepared for individual devices to transmit a small asynchronous notification message to the host device. There are prepared a plurality of DNTSs. Each device acquires and holds the host identification information when the cluster to which its own device belongs is structured. Based on the host identification information included in the MMC sent from the host device, the device determines whether a host device is a host device of the cluster to which its own device belongs. In a case of issuing the connection request to the host device of the cluster to which its own device belongs, the device randomly selects a slot for transmitting a message, from the prepared slots, and issues the connection request. After that, mutual authentication between the host device and the device is performed by handshake, to thereby complete the connection.

In a WUSB system, a host device takes charge in data transmission between the host device and devices in a cluster. To a plurality of devices for performing data transmission with the host device, the host device allocates a time zone for each of the devices to transmit/receive data to thereby schedule the devices, and sends a data transmission request to each of the devices via the MMC as scheduled. In this case, a case where the host device requests a device to transmit data is described as an example.

In the case of requesting a device to transmit data, the host device transmits a WdtCTA (dt: Data Transmit) via the MMC. The WdtCTA includes identification information of each device requested to transmit data, and information for specifying a time at which the device is to transmit data (hereinafter, referred to as “time specifying information”).

When the device requested to transmit data is ready for data to be transmitted, the device transmits the data to the host device at a time indicated by the time specifying information included in the WdtCTA. On the other hand, when the data cannot be transmitted, for example, when the data to be transmitted is not ready, the device sends a negative acknowledgement (NAK) response to the host device at the time indicated by the time specifying information. Upon reception of the NAK response, the host device temporarily excludes the device having sent the NAK response, from a scheduling target. Such a state of the device is referred to as “under flow control”. In this case, if there are other devices transmitting data, the host device continuously schedules those devices. For ease of explanation, in FIG. 5, only the WdtCTA for the device having sent the NAK response is illustrated. As shown in FIG. 5, to the device having sent the NAK response and being under the flow control, the WdtCTA for the device is not transmitted from the host device.

When the device under the flow control completes preparation of data and is ready for data transmission, the device transmits a device notification indicating to that effect to the host device, thereby requesting the host device to resume data transmission. Upon reception of the device notification from the device, the host device resumes transmission of the WdtCTA for the device.

Incidentally, in a WUSB system, the device notification can be transmitted by a device only in a bandwidth secured by the WdntsCTA. On the other hand, a transmission interval of the WdntsCTA, which is normally set in several msec, is determined on the side of the host device, and cannot be controlled on a side of the device. Accordingly, as shown in FIG. 5, even in a case where the device under the flow control has completed preparation of the data, there may occur a case where the device has to wait for the WdntsCTA so as to transmit the device notification for requesting to resume data transmission. As a result, there arises a problem in that data transmission is interrupted and the efficiency is lowered.

### SUMMARY

In one embodiment, the present invention provides a response control method. The response control method is capable of causing a device which has received a data transmission request from a host device that excludes, from a transmission target of the data transmission request, a device having sent a waiting response indicating that transmission data is not ready in response to the data transmission request, to send a retransmission response for causing the host device to retransmit the data transmission request, instead of the waiting response, in a case where the transmission data is not ready when the data transmission request is received.

Note that the above method replaced with an apparatus or a system, and a device to which the above method is applied are also effective as an embodiment of the present invention.

With a technology of the present invention, in a system in which a device transmits data in response to a data transmission request from a host device, there is controlled a response to be made in a case where transmission data is not ready when the device receives the transmission request, which leads to improvement of a data transmission efficiency.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a WUSB system according to an embodiment of the present invention;

FIG. 2 is a diagram showing a device in the WUSB system shown in FIG. 1;

FIG. 3 is a flowchart showing processing of a control unit of the device shown in FIG. 2;

FIG. 4 is a diagram showing an example of a timing chart of data transmission processing executed by a host device and a device in the WUSB system shown in FIG. 1; and

FIG. 5 is a diagram for illustrating a related art.

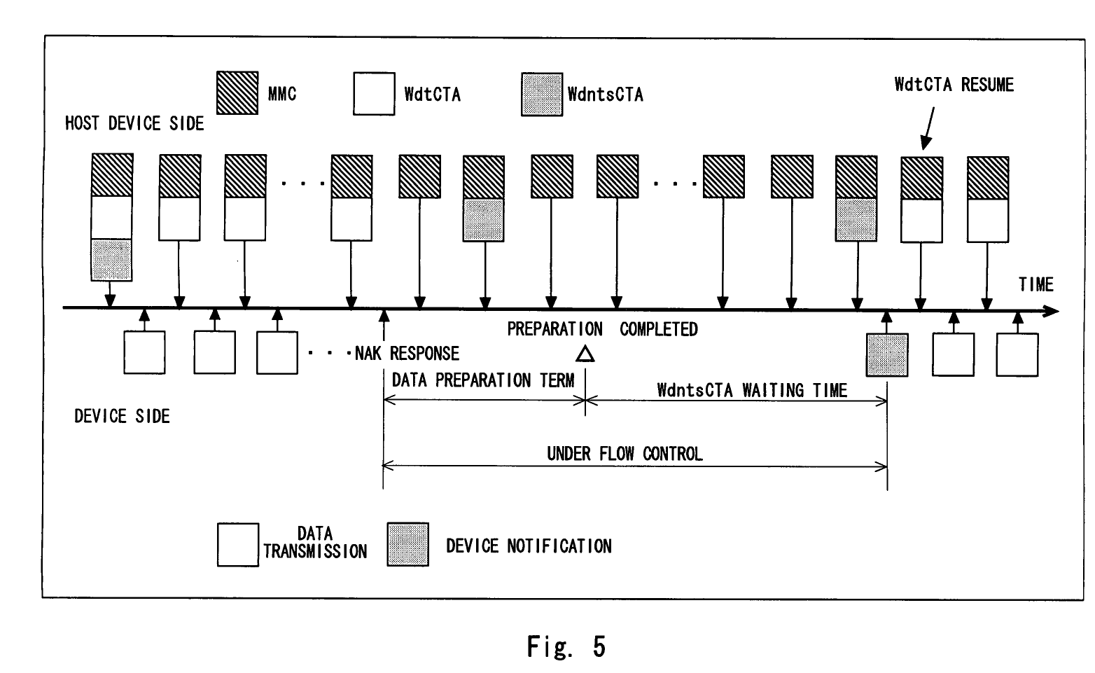

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Hereinafter, exemplary embodiments of the present invention will be described with reference to the drawings.

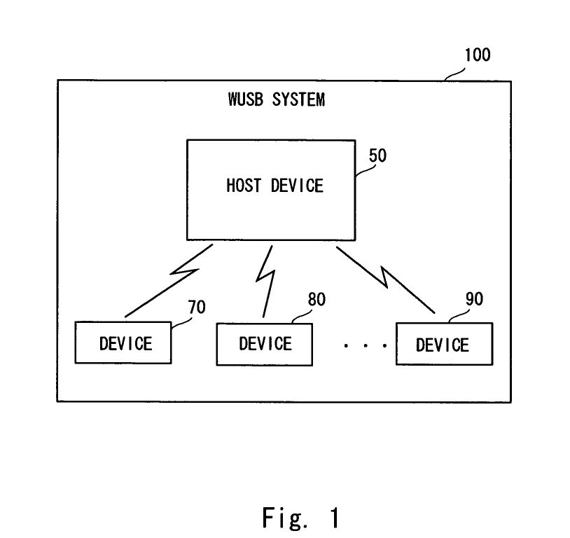

FIG. 1 shows a WUSB system 100 according to a first embodiment of the present invention. The WUSB system 100 includes a host device 50 and a plurality of devices (three devices in illustrated example: device 70, device 80, and device 90).

The host device 50 is, for example, a PC, and includes hardware and software, each of which complies with the WUSB standard, incorporated therein. The host device 50 is a typical host device in a WUSB system, and a detailed description thereof is omitted.

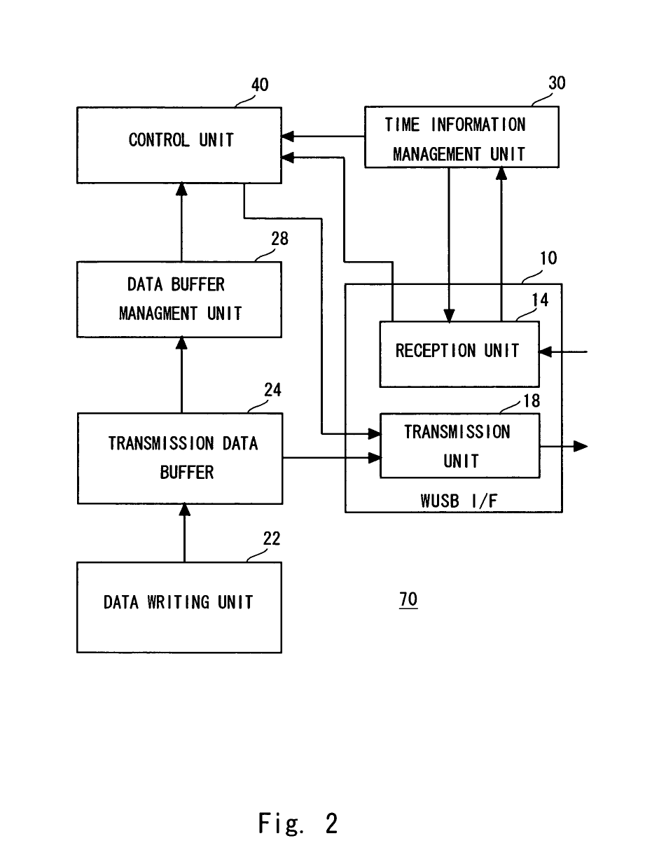

The device 70, the device 80, and the device 90, each of which complies with the WUSB standard, are, for example, a printer, a hard disk, a mouse, a digital camera, a game console, and a PDA, and are connected wirelessly to the host device 5 to be used. In this case, referring to FIG. 2, the device 70 is described. Note that, for ease of understanding of the gist of the present invention, only a part involved in processing relevant to the present invention is described below and illustrated.

As shown in FIG. 2, the device 70 includes a WUSB interface (hereinafter, referred to as “WUSB I/F”) 10, a data writing unit 22, a transmission data buffer 24, a data buffer management unit 28, a time information management unit 30, and a control unit 40. Note that components shown in FIG. 2 as functional blocks performing various processings for the device 70 can be configured by an LSI such as a CPU or a memory in terms of hardware, and also can be achieved by a program or the like loaded in a memory in terms of software. Accordingly, it is obvious for those skilled in the art that those functional blocks can be implemented in any form using only hardware, only software, or a combination thereof, and the functional blocks are not limited to any one of the above.

The WUSB I/F 10 complies with the WUSB standard, and data is transmitted between the device 70 and the host device 50 via the WUSB I/F 10. The WUSB I/F 10 includes a reception unit 14 for receiving data or a data transmission request from the host device 50, and a transmission unit 18 for transmitting data or a response from the device 70 to the host device 50.

The data writing unit 22 writes data to be transmitted from the device 70 to the host device 50 (hereinafter, referred to as “transmission data”), into the transmission data buffer 24, to thereby prepare the transmission data.

The transmission data buffer 24 temporarily stores the transmission data, and is configured by, for example, a memory.

When the reception unit 14 receives a WdtCTA from the host device 50, the control unit 40 controls whether the transmission unit 18 is caused to output transmission data, and controls a response in a case where the transmission data is not output. Specifically, in a case where the transmission data is ready when the WdtCTA is received, the control unit 40 causes the transmission unit 18 to output the transmission data. Meanwhile, in a case where the transmission data is not ready, the control unit 40 causes the transmission unit 18 to send one of a waiting response, and a retransmission response for causing the host device 50 to retransmit the WdtCTA. In the first embodiment of the present invention, the waiting response corresponds to a NAK response, and the retransmission response corresponds to an error response.

As to which response is to be made, the control unit 40 first estimates a time at which the device 70 completes preparation of the transmission data (preparation completion time), and compares the estimated preparation completion time with an earliest time (hereinafter, referred to as “time T0”) at which the host device 50 can retransmit a data transmission request. Then, when the estimated preparation completion time is before the time T0, the control unit 40 causes the transmission unit 18 to send the error response, and when the estimated preparation completion time is after the time T0, the control unit 40 causes the transmission unit 18 to send the NAK response.

Based on information managed by the data buffer management unit 28 and the time information management unit 30, the control unit 40 determines whether the transmission data is ready, which response is to be made, and the like.

The data buffer management unit 28 manages information for determination whether the transmission data is ready, and information for estimating a time at which the transmission data is ready in the case where the transmission data is not ready. Specifically, the data buffer management unit 28 manages a free space of the transmission data buffer 24, and a state of writing by the data writing unit 22. In the first embodiment, for example, the transmission data buffer 24 has a capacity corresponding to a data amount to be transmitted at one time by the transmission unit 18, and a state where the data corresponding to the capacity of the transmission data buffer 24 is stored, that is, a state where there is no free space in the transmission data buffer 24, indicates that the transmission data is ready. Further, the state of writing corresponds to, for example, information for determination whether the data writing unit 22 has made write access to the transmission data buffer 24, or information for estimating a time for preparing the transmission data based on frequency of the write access and the like in the case where the write access has been made. The information is hereinafter referred to as “access information”.

The time management unit 30 manages various time information included in an MMC or WdtCTA received by the reception unit 14 of the WUSB I/F 10 from the host device 50, and provides the various time information to the control unit 40. Specifically, when the reception unit 14 receives the MMC or WdtCTA, the time information management unit 30 acquires and temporarily stores a transmission time for a subsequent MMC, which is included in the MMC, and time specifying information included in the WdtCTA, and provides the transmission time and the time specifying information to the control unit 40.

The time information management unit 30 manages not only the time information but also communication impossible time zone information indicating a time zone during which communication between the device 70 and the host device 50 is impossible. In the WUSB standard, there is provided a structure (device availability) in which a communication impossible time zone is intermittently provided between the device and the host device so as to avoid interference of radio wave between clusters in a case where another WUSB cluster exists in the vicinity of the device. The communication impossible time zone information is preset, and during the communication impossible time zone thus set, the host device does not transmit the WdtCTA to the device. The structure of the device availability is applied to the WUSB system 100 according to the first embodiment so that the host device 50 does not transmit the WdtCTA to the device 70 during the communication impossible time zone.

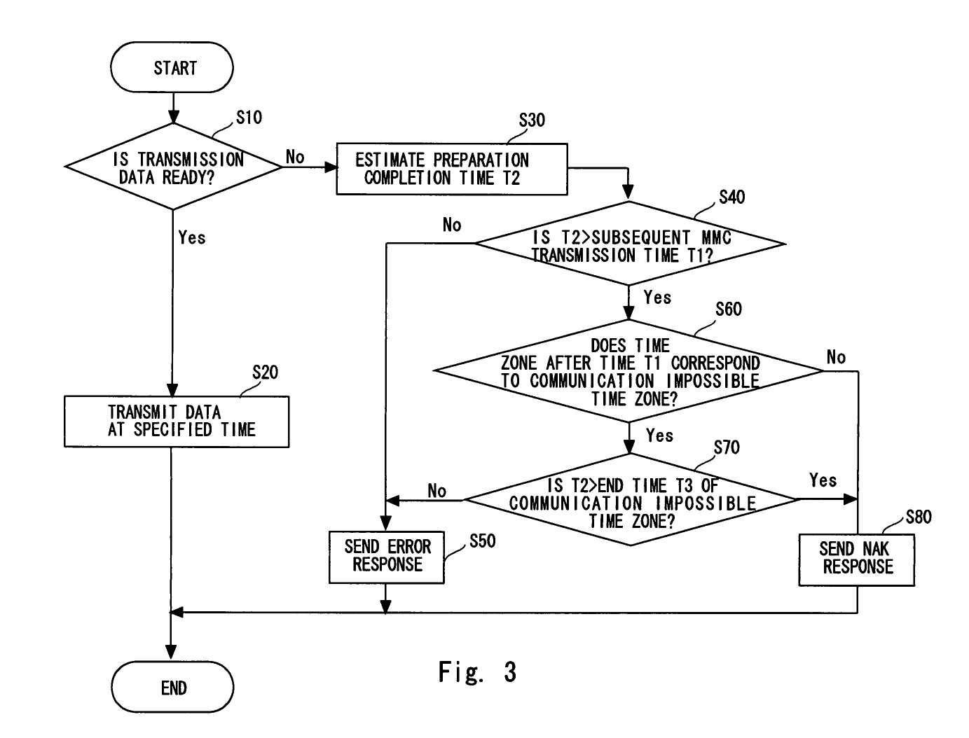

Referring to FIG. 3, the control unit 40 is described in more detail. FIG. 3 is a flowchart showing processing executed by the control unit 40. When the reception unit 14 receives the WdtCTA, the control unit 40 refers to the information managed by the data buffer management unit 28, and confirms whether the transmission data is ready (S10). When the transmission data buffer 24 has no free space, the control unit 40 determines that the transmission data is ready, and causes the transmission unit 18 to output the transmission data stored in the transmission data buffer 24 at the time indicated by the time specifying information for the current WdtCTA in the time information management unit 30 (S10: Yes, S20).

On the other hand, when the transmission data buffer 24 has a free space, the control unit 40 determines that the transmission data is not ready, and estimates a preparation completion time T2 for the transmission data (S10: No, S30). Specifically, for example, in a case where the access information indicates that the write access to the transmission data buffer 24 has been made by the data writing unit 22 and that a writing amount per unit time is R1, the control unit 40 calculates a time for preparing the transmission data by “free space of transmission data buffer 24/R”, and a time obtained by adding the calculated time to the current time is estimated as the preparation completion time T2. Hereinafter, the time T2 is called “estimated time”.

The control unit 40 compares the preparation completion time T2 with a time for the host device 50 to transmit a subsequent MMC (hereinafter, referred to as “time T1”) (S40). The time T1 is included in the MMC when the current WdtCTA is received, and is managed by the time information management unit 30.

In a case where the preparation completion time T2 is equal to or before the time T1, the control unit 40 causes the transmission unit 18 to output the error response (S40: No, S50).

Meanwhile, in a case of the preparation completion time T2 is after the time T1, the control unit 40 refers to the communication impossible time zone information managed by the time information management unit 30, and confirms whether a time-zone after the time T1 is included in the communication impossible time zone between the device 70 and the host device 50 (S40: Yes, S60).

When the time zone after the time T1 is included in the communication impossible time zone and the preparation completion time T2 is before an end time T3 of the communication impossible time zone (S60: Yes, S70: No), the control unit 40 causes the transmission unit 18 to output the error response (S50). Meanwhile, when the time zone after the time T1 is not included in the communication impossible time zone (S60: No), or when the time zone after the time T1 is included in the communication impossible time zone while the preparation completion time T2 is after the end time T3 of the communication impossible time zone (S60: Yes, S70: Yes), the control unit 40 causes the transmission unit 18 to output the NAK response (S80).

As described above, since the WdtCTA is transmitted via the MMC, it is impossible to set a transmission time for a subsequent WdtCTA before a transmission time for a subsequent MMC. Accordingly, when the time zone after the time T1 for transmitting the subsequent MMC is not included in the communication impossible time zone, the time T1 is determined as the earliest time T0 at which the host device 50 can transmit the WdtCTA to the device 70. Meanwhile, since the host device does not transmit the WdtCTA to the device 70 during the communication impossible time zone, when the time zone after the time 1 is included in the communication impossible time zone, the end time T3 of the communication impossible time zone is determined as the earliest time T0 at which the host device 50 can transmit the WdtCTA to the device 70.

In other words, in a case where the host device 50 is not ready for the transmission data on the side of the device 70 by the earliest time T0 at which the host device 50 can transmit the WdtCTA to the device 70, the control unit 40 causes the transmission unit 18 to send the NAK response and is under the flow control. When the transmission data is ready by the time T0, the control unit 40 causes the transmission unit 18 to send the error response instead of the NAK response. Even when the host device 50 transmits the WdtCTA at the earliest time T0 at which the host device 50 can transmit the WdtCTA in response to the error response, since the transmission data is ready by that time, the device 70 can output the transmission data.

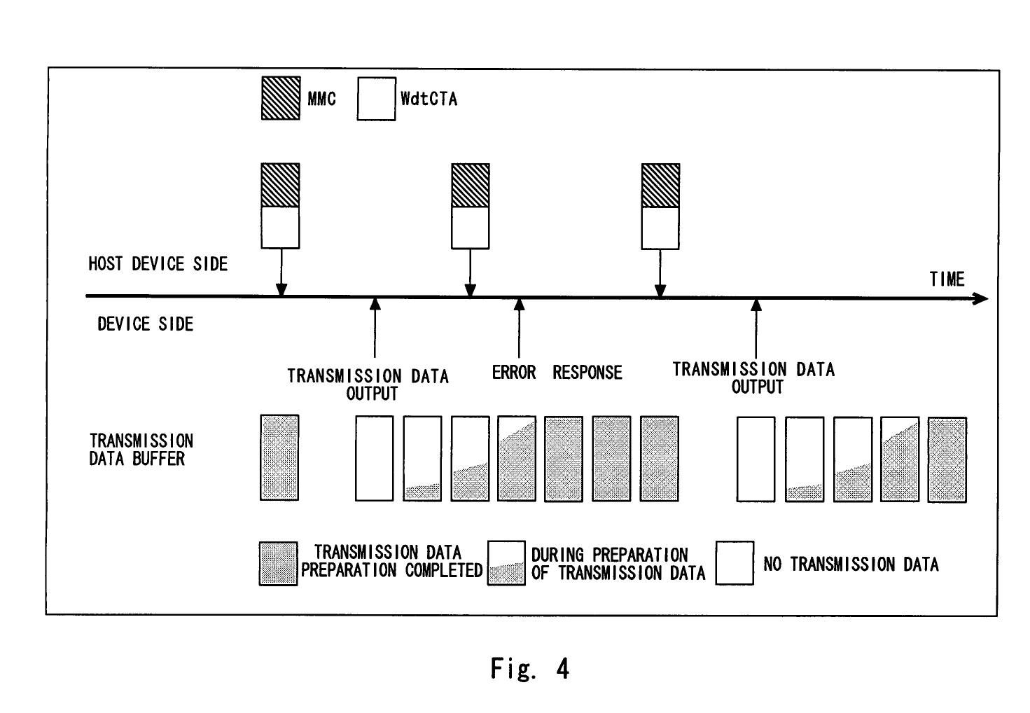

FIG. 4 shows an example of a timing chart of data transmission processing executed by the host device 50 and the device 70. This example shows a case where the transmission data is not ready when the device 70 receives the WdtCTA from the host device 50 but the preparation completion time T2 is before the earliest time T0 at which the host device 50 can retransmit the WdtCTA. This example corresponds to a case of “S10: No, S30, S40: No, S50” or a case of “S10: No, S30, S40: Yes, S60: Yes, S70: No, S50” shown in the flowchart of FIG. 3. A description thereof is given below on a time base.

As shown in FIG. 4, in the device 70, when the WdtCTA is received from the host device 50 in a state where the transmission data buffer 24 has no free space and the transmission data is ready, the device 70 outputs the transmission data to the host device 50 at the time specified by the WdtCTA. As a result, the transmission data buffer 24 is cleared. Then, the write access to the transmission data buffer 24 by the data writing unit 22, that is, the preparation of the transmission data is performed. Upon reception of the subsequent WdtCTA from the host device 50 during the preparation of the transmission data, the device 70 sends the error response to the host device 50 to request retransmission of the WdtCTA, thereby avoiding being subjected to the flow control.

The response from the device 70 is not the NAK response, so the host device 50 does not exclude the device 70 from a scheduling target but retransmit the WdtCTA to the device 70. Upon reception of the retransmitted WdtCTA, the device 70 outputs the transmission data because the transmission data is ready.

Thus, in the WUSB system 100 according to the first embodiment, even when the device 70 is not ready for the transmission data upon reception of the WdtCTA, as long as the time T2 at which the transmission data is ready is before the earliest time T0 at which the host device 50 can retransmit the WdtCTA, the device 70 sends the error response intentionally instead of the NAT response, whereby the frequency of being subjected to the flow control can be reduced. As a result, this leads to a reduction in time required for a process in which the device 70 is subjected to the flow control and returns from the state under the flow control in the case of sending the NAK response, and also leads to improvement of a data transmission efficiency.

Note that only the device 70 has been described above, but a response control similar to that for the device 70 can also be applied to the device 80, the device 90, and other devices.

The present invention has been described above with reference to exemplary embodiments. The embodiments are illustrative, and various alterations, additions, and omissions may be made without departing from the scope of the present invention. It is understood by those skilled in the art that modified examples in which the alterations, additions, and omissions are made are also within the scope of the present invention.

For example, in the WUSB system 100, the device 70 sends the error response to the host device 50 to request the retransmission of the WdtCTA. However, the response is not limited to the error response, but there may be employed any response capable of avoiding being subjected to the flow control and capable of causing the host device to retransmit the WdtCTA. For example, instead of the error response, “no response” may be made.

Further, the structure of “device availability” is applied to the WUSB system 100 so that the host device 50 does not transmit the WdtCTA to the device 70 during the communication impossible time zone for the device 70. In the case of acquiring the earliest time T0 at which the host device can retransmit the WdtCTA, by utilizing the structure, the device 70 takes into consideration of the communication impossible time zone of its own which is notified to the host device 50 in advance, to thereby secure a longer time that can be used for the preparation of the transmission data. When the structure of “device availability” is not applied, the time T1 for transmitting the subsequent MMC may be set as the time T0.

Further, the embodiments of the present invention are examples where the technology involved in the present invention is applied to a WUSB system. The technology of the present invention can be applied to any system in which a device outputs transmission data in response to a data transmission request from a host device, and when the device sends a waiting response in a case where the transmission data is not ready when the data transmission request is received, the device is excluded from the transmission target of the data transmission request. As a result of applying the technology of the present invention to those systems, the frequency of excluding the device from the transmission target of the data transmission request can be reduced, and the data transmission efficiency can be improved.

It is apparent that the present invention is not limited to the above embodiments, but may be modified and changed without departing from the scope and spirit of the invention.

What is claimed is:

1. A device which transmits transmission data in response to a data transmission request from a host device that excludes a device having sent a waiting response indicating that the transmission data is not ready in response to the data transmission request, comprising:
a reception unit receiving the data transmission request; and
a response control unit controlling a response to be made in a case where the transmission data is not ready when the data transmission request is received by the reception unit,
wherein the response control unit is capable of controlling the response so as to send a retransmission response for causing the host device to retransmit the data transmission request, instead of the waiting response.

2. The device according to claim 1, wherein the response control unit:
acquires an earliest retransmission time at which the host device can retransmit the data transmission request;
estimates a preparation completion time at which preparation of the transmission data is completed; and
controls the response so as to send the retransmission response when the preparation completion time estimated is before the earliest retransmission time, and so as to send the waiting response when the preparation completion time estimated is after the earliest retransmission time.

3. The device according to claim 2, further comprising:
a transmission data buffer temporarily storing the transmission data; and
a writing unit writing the transmission data into the transmission data buffer to prepare the transmission data,
wherein the response control unit estimates the preparation completion time based on an amount of data stored in the transmission data buffer and a state of writing into the transmission data buffer by the writing unit.

4. The device according to claim 1, wherein the response control unit controls the response so as to send an error response as the retransmission response.

5. The device according to claim 2, wherein the response control unit controls the response so as to send an error response as the retransmission response.

6. The device according to claim 3, wherein the response control unit controls the response so as to send no response as the retransmission response.

7. A device according to claim 1, wherein the response control unit controls the response so as to send no response as the retransmission response.

8. The device according to claim 2, wherein the response control unit controls the response so as to send no response as the retransmission response.

9. The device according to claim 3, wherein the response control unit controls the response so as to send no response as the retransmission response.

10. The device according to claim 1, wherein:
the host device and the device each comply with a wireless universal serial bus (WUSB) standard, and the host device transmits the data transmission request via a micro-scheduled management command (MMC); and
the response control unit acquires, as an earliest retransmission time at which the host device can retransmit the data transmission request, a time for the host device to subsequently transmit the MMC, the time being included in the MMC received together with the data transmission request by the reception unit.

11. The device according to claim 2, wherein:
the host device and the device each comply with a wireless universal serial bus (WUSB) standard, and the host device transmits the data transmission request via a micro-scheduled management command (MMC); and
the response control unit acquires, as the earliest retransmission time, a time for the host device to subsequently transmit the MMC, the time being included in the MMC received together with the data transmission request by the reception unit.

12. The device according to claim 3, wherein:
the host device and the device each comply with a wireless universal serial bus (WUSB) standard, and the host device transmits the data transmission request via a micro-scheduled management command (MMC); and
the response control unit acquires, as the earliest retransmission time, a time for the host device to subsequently transmit the MMC, the time being included in the MMC received together with the data transmission request by the reception unit.

13. The device according to claim 1, wherein:
the host device and the device each comply with a wireless universal serial bus (WUSB) standard, and the host device transmits the data transmission request to the device via a micro-scheduled management command (MMC) during a time zone other than a communication impossible time zone during which communication between the device and the host device is impossible, the communication impossible time zone being preset; and
the response control unit acquires, as an earliest retransmission time at which the host device can retransmit the data transmission request, an end time of the communication impossible time zone, when a time zone after a time for the host device to subsequently transmit the MMC is included in the communication impossible time zone, the time being included in the MMC received together with the data transmission request by the device.

14. The device according to claim 2, wherein:
the host device and the device each comply with a wireless universal serial bus (WUSB) standard, and the host device transmits the data transmission request to the device via a micro-scheduled management command (MMC) during a time zone other than a communication impossible time zone during which communication between the device and the host device is impossible, the communication impossible time zone being preset; and
the response control unit acquires, as the retransmission time, an end time of the communication impossible time zone, when a time zone after a time for the host device to subsequently transmit the MMC is included in the communication impossible time zone, the time being included in the MMC received together with the data transmission request by the device.

15. The device according to claim 3, wherein:
the host device and the device each comply with a wireless universal serial bus (WUSB) standard, and the host device transmits the data transmission request to the device via a micro-scheduled management command (MMC) during a time zone other than a communication impossible time zone during which communication between the device and the host device is impossible, the communication impossible time zone being preset; and
the response control unit acquires, as the retransmission time, an end time of the communication impossible time zone, when a time zone after a time for the host device to subsequently transmit the MMC is included in the communication impossible time zone, the time being included in the MMC received together with the data transmission request by the device.

16. A response control method, comprising:
controlling a response of a device having received a data transmission request from a host device that excludes, from a transmission target of the data transmission request, a device having sent a waiting response indicating that transmission data is not ready in response to the data transmission request, in a case where the transmission data is not ready when the data transmission request is received,
wherein the controlling is capable of causing the device to send a retransmission response for causing the host device to retransmit the data transmission request, instead of the waiting response.

17. The response control method according to claim 16, further comprising:
acquiring an earliest retransmission time at which the host device can retransmit the data transmission request;
estimating a preparation completion time at which the device completes preparation of the transmission data; and
controlling the device to send the retransmission response when the preparation completion time estimated is before the earliest retransmission time, and to send the waiting response when the preparation completion time estimated is after the earliest retransmission time.

18. The response control method according to claim 17, wherein:
the device writes the transmission data into a transmission data buffer temporarily storing the transmission data, to thereby prepare the transmission data; and
the device estimates the preparation completion time based on an amount of data stored in the transmission data buffer and a state of writing into the transmission data buffer.

19. The response control method according to claim 16, wherein:
the host device and the device each comply with a wireless universal serial bus (WUSB) standard, and the host device transmits the data transmission request via a micro-scheduled management command (MMC); and
the device acquires, as an earliest retransmission time at which the host device can retransmit the data transmission request, a time for the host device to subsequently transmit the MMC, the time being included in the MMC received together with the data transmission request by the device.

20. The response control method according to claim 16, wherein:
the host device and the device each comply with a wireless universal serial bus (WUSB) standard, and the host device transmits the data transmission request to the device via a micro-scheduled management command (MMC) during a time zone other than a communication impossible time zone during which communication between the device and the host device is impossible, the communication impossible time zone being preset; and
the device acquires, as an earliest retransmission time at which the host device can retransmit the data transmission request, an end time of the communication impossible time zone, when a time zone after a time for the host device to subsequently transmit the MMC is included in the communication impossible time zone, the time being included in the MMC received together with the data transmission request by the device.
